(19) United States
(12) Patent Application Publication
(10) Pub. No.: US 2025/0316783 A1
(43) Pub. Date: Oct. 9, 2025

(54) EXPANSION TANK AND BATTERY COOLING SYSTEM

(71) Applicant: MAHLE International GmbH, Stuttgart (DE)

(72) Inventors: Markus Lang, Loechgau (DE); Ralf Zink, Stuttgart (DE)

(21) Appl. No.: 18/981,433

(22) Filed: Dec. 13, 2024

(30) Foreign Application Priority Data
Dec. 15, 2023 (DE) 10 2023 135 282.2

(51) Int. Cl. H01M 10/52; H01M 10/613; H01M 50/317

(52) U.S. Cl. CPC H01M 10/52; H01M 10/613; H01M 50/317

(57) ABSTRACT

An expansion tank for a battery cooling system may include a tank housing composed of a plastic, a first receptacle, a dryer cartridge positively received in the first receptacle, a first valve via which air is released from the expansion tank into an environment when there is excess pressure in the expansion tank, and a second valve via which fresh air from the environment enters the expansion tank when there is a vacuum in the expansion tank. The tank housing may include a first shell and a second shell connected to the first shell. The first receptacle may be disposed in at least one of the first shell or the second shell.

### CROSS-REFERENCE TO RELATED APPLICATIONS

This application claims priority to German Patent Application No. DE 10 2023 135 282.2, filed on Dec. 15, 2023, the contents of which is hereby incorporated by reference in its entirety.

### TECHNICAL FIELD

The present invention relates to an expansion tank for a battery cooling system. The invention also relates to a battery cooling system with such an expansion tank.

### BACKGROUND

Electric or hybrid vehicles are increasingly becoming the focus of consumers due to environmental aspects and are therefore also becoming more widespread on the roads. In order to be able to increase both the range and the performance of such electric or hybrid vehicles, the aim is to keep a traction battery of such an electric or hybrid vehicle in an optimum temperature window for this traction battery, for which temperature control devices, in particular cooling devices, are used in a known manner. In order to achieve particularly efficient cooling, so-called immersion cooling is also used, in which a dielectric, i.e., electrically non-conductive, coolant flows around individual battery cells of the traction battery.

Such a battery cooling system for cooling a traction battery in particular also includes an expansion tank in which air is stored as an expansion cushion for a temperature-related change in volume of the coolant. An increase in temperature causes the coolant to expand, which could lead to a high pressure load in the expansion tank and possibly damage it if the resulting excess pressure cannot escape and should therefore be avoided. For this reason, such expansion tanks usually have a connection to the environment in order to be able to reduce a temperature-related pressure difference by blowing air into the environment if necessary. When the coolant cools down, it contracts, creating a vacuum in the expansion tank, which leads to fresh air being drawn in from the environment. In order to prevent or at least reduce the undesirable introduction of moisture into the coolant, so-called dryer cartridges have been provided to date, in which a drying agent was arranged, through which the fresh air drawn in from the environment flowed during the intake process, absorbing moisture and drying the fresh air drawn in.

However, the disadvantage of such dryer cartridges is that they have a sheet metal housing and are therefore not only heavy, but also comparatively expensive. In addition, a threaded nipple had to be provided via which the dryer cartridge was screwed to the expansion tank. Such a threaded nipple made of sheet metal is also expensive.

### SUMMARY

The present invention therefore deals with the problem of providing an improved or at least an alternative embodiment for an expansion tank, by means of which the disadvantages known from the prior art can be overcome.

According to the invention, this problem is solved by the subject matter of the independent claim(s). Advantageous embodiments are the subject matter of the dependent claim(s).

The present invention is based on the general idea of not forming a dryer cartridge with a housing made of sheet metal, as has been customary up to now, and arranging it on a tank housing of an expansion tank, in particular for air in a battery cooling system, via threaded nipples which are difficult and therefore also expensive to manufacture, but instead forming the tank housing of the expansion tank for air or coolant for a battery cooling system as a low-cost double-shell plastic housing and integrating a dryer cartridge into this as an insert part. The expansion tank is used to buffer a volume of air due to a temperature-related change in the volume of a cooling medium, in particular oil. The expansion tank according to the invention, in particular for air, for a battery cooling system has the aforementioned tank housing made of plastic with a first shell and a second shell tightly connected thereto. In the first shell and/or in the second shell, a first receptacle is/are formed in which the aforementioned dryer cartridge with a drying agent, for example zeolite or silica gel, is accommodated in a form-fitting manner. A first valve is also provided, via which air can be blown out of the expansion tank into the environment when there is excess pressure in the expansion tank, and a second valve, via which fresh air can be sucked into the expansion tank from the environment when there is negative pressure in the expansion tank. The term “fresh air” can/should be understood as ambient air. The double-shell design of the tank housing of the expansion tank with the dryer cartridge arranged therein, which is preferably not replaceable, makes it possible to create an overall very cost-effective tank housing of the expansion tank, while at the same time providing assembly advantages, since the dryer cartridge, which is designed as an insert, only has to be inserted into the first receptacle of the first and/or second shell in a form-fitting manner and then the two shells of the tank housing have to be tightly connected to each other. This also makes it possible to achieve an arrangement of the dryer cartridge in the tank housing that is protected over its service life. This completely eliminates the need to manufacture the tank housing and subsequently install the dryer cartridge. The manufacture of the expansion tank according to the invention can in particular even be automated, since the inner contour of the first receptacle, which is essentially complementary to an outer contour of the dryer cartridge, allows the dryer cartridge to be inserted into the first receptacle in a form-fitting manner, for which no worker is required. Due to the arrangement of both the first valve and the second valve on the tank housing, these two valves can also be replaced when the dryer cartridge is replaced at regular intervals and therefore also when the tank housing is replaced at regular intervals, which can reliably prevent the valves from clogging due to excessive use, for example.

In an advantageous further development of the expansion tank according to the invention, a second receptacle is formed in the first shell and/or in the second shell, in which an activated carbon cartridge is positively received. Such an activated carbon cartridge is able to absorb pollutants, such as hydrocarbons, such that air is blown out via the activated carbon cartridge when there is excess pressure in the expansion tank, thereby purifying the blown-out air and preventing hydrocarbons from being blown out. Due to the positive fit of the activated carbon cartridge in the second receptacle of the first and/or second tray, the activated carbon cartridge can also be inserted into the second receptacle, preferably automatically, in the same way as the dryer cartridge before the two trays are joined together. This also makes it possible to achieve a protected arrangement of the activated carbon cartridge in the tank housing.

In an advantageous further development of the expansion tank according to the invention, the first valve is arranged in an intermediate wall which separates the second receptacle from an interior of the tank housing. Air is usually arranged in the interior of the tank housing, which is pressurized or depressurized depending on the temperature of the coolant by expansion or contraction of the coolant. By arranging the first valve in the partition wall that separates the second receptacle from the interior of the tank housing, the first valve can be directly assigned to the second receptacle. Downstream of the second receptacle, there is of course an opening in one wall of the tank housing to the outside for exchange with the environment.

The second valve is arranged in an outer wall of the tank housing, wherein the outer wall, in which the second valve is arranged, separates the first receptacle from the environment. Fresh air is thus drawn in from the environment when there is a vacuum in the tank housing or in the expansion tank via the second valve and the first receptacle in which the dryer cartridge is arranged. The fresh air drawn in from the environment is thus sucked in by the drying agent of the dryer cartridge and dried in the process, which in particular prevents moisture and/or water from entering the expansion tank. Excessive moisture could make the coolant electrically conductive, which can lead to a short circuit under unfavorable circumstances, particularly in the case of immersion cooling.

The second valve described can also be designed as a double valve, which also allows air to be blown out of the tank housing into the environment.

In a particularly preferred embodiment, a spring is provided in the first or second receptacle, which pretensions the dryer cartridge or the activated carbon cartridge against the tank housing. Such springs can be used to achieve a reliable and positionally fixed arrangement of the dryer cartridge in the first receptacle and the activated carbon cartridge in the second receptacle, wherein the spring preload also prevents the dryer cartridge and/or the activated carbon cartridge from generating rattling noises during operation, which are perceived as disturbing, for example. Such a spring can, for example, be designed as an inexpensive coil spring, wherein the coil spring for pretensioning the dryer cartridge can be arranged in the first receptacle in such a way that it engages around the second valve in the outer wall of the tank housing and is thereby fixed by the second valve. The spring preload also compresses the dryer granulate or activated carbon such that it has no room to move and can wear out.

In a particularly preferred embodiment of the expansion tank according to the invention, the first shell and/or the second shell is/are designed as plastic injection molded part(s). The design of the first and/or second shell as plastic injection molded parts offers the great advantage of being able to manufacture the tank housing and thus also the expansion tank not only to a high quality, but also cost-effectively.

The first and second shells are conveniently welded together. When the two shells are designed as plastic injection-molded parts, it makes sense to weld them together to form a tight connection. Alternatively, the two shells can of course also be glued together. Alternatively, it is theoretically conceivable that the two shells could be connected to each other via clip connections or screw connections, which offers the great advantage that the tank housing can be opened to replace the dryer cartridge or activated charcoal cartridge and can continue to be used after the dryer cartridge or activated charcoal cartridge has been replaced. In this case, a seal must be inserted between the two shells.

In a further advantageous embodiment of the expansion tank according to the invention, the first shell and/or the second shell is/are made of polyoxymethylene (POM). POM is a semi-crystalline thermoplastic with high mechanical strength and rigidity and, in addition, high wear resistance and low moisture absorption, which is particularly advantageous when used for the expansion tank according to the invention, since in this case water retention or moisture absorption increases the electrical conductivity of a dielectric coolant. Polyketones are also suitable as a material for the first and/or second shell. In order to further increase the mechanical strength and also the wear resistance, the plastic can have glass fibers, in particular 25% glass fibers, and in particular be designed as POM GF-25.

The present invention is further based on the general idea of equipping a battery cooling system with an expansion tank described in the previous paragraphs and thereby transferring the advantages described with respect to the expansion tank to the battery cooling system. Specifically, the advantages of a battery cooling system equipped with the expansion tank according to the invention lie in its cost-effective manufacture, wherein only the expansion tank needs to be replaced when the dryer cartridge and/or the activated carbon cartridge is replaced at regular intervals.

Further important features and advantages of the invention are apparent from the sub-claims, from the drawings and from the associated description of the figures with reference to the drawings.

It is understood that the features mentioned above and those to be explained below can be used not only in the combination indicated in each case, but also in other combinations or on their own, without departing from the scope of the present invention. The above-mentioned components of a superordinate unit, such as a device, an apparatus or an arrangement, which are designated separately, can form separate parts or components of this unit or be integral areas or sections of this unit, even if this is shown differently in the drawing.

Preferred embodiments of the invention are shown in the drawings and are explained in more detail in the following description, with identical reference signs referring to identical or similar or functionally identical components.

### BRIEF DESCRIPTION OF THE DRAWINGS

It shows, schematically in each case

FIG. 1 shows a view of an expansion tank of a battery cooling system according to the invention,

FIG. 2 shows a representation as in FIG. 1, but from a different perspective,

FIG. 3 shows an interior view of the expansion tank according to the invention,

FIG. 4 shows an interior view of an expansion tank for air not covered by the invention.

### DETAILED DESCRIPTION

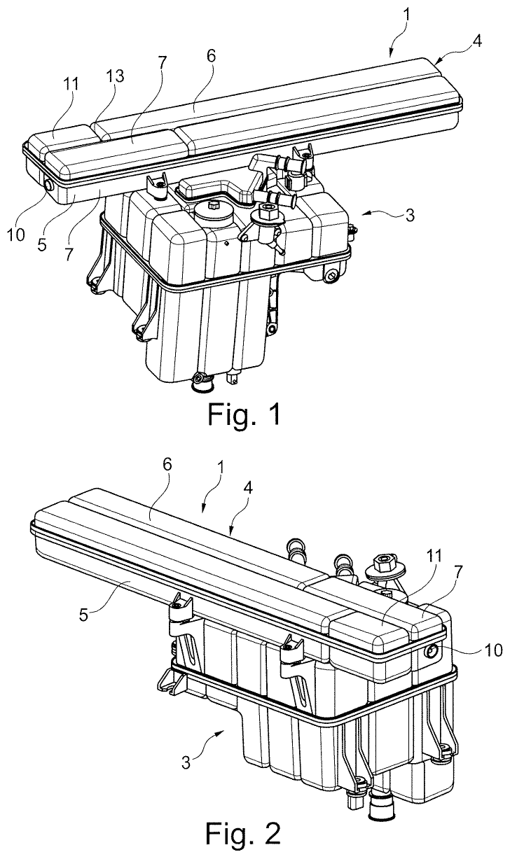

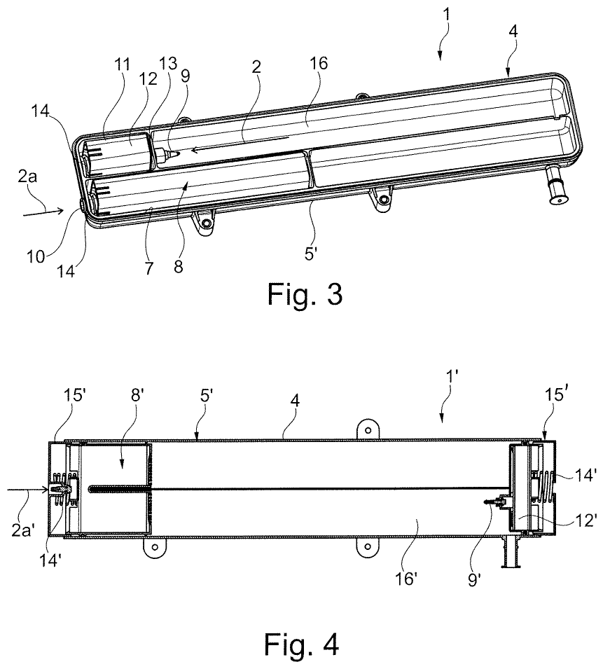

According to FIGS. 1 to 3, an expansion tank 1 for air 2 of a battery cooling system 3 according to the invention has a tank housing 4 made of plastic with a first shell 5 and a second shell 6 connected thereto. In the first shell 5 and/or in the second shell 6, a first receptacle 7 (see FIG. 3) is/are provided or formed, in which a dryer cartridge 8 is arranged in a form-fitting manner. An unspecified drying agent is arranged in the dryer cartridge 8. Furthermore, the expansion tank 1 according to the invention has a first valve 9, via which air 2 can be blown out of the expansion tank 1 into the environment when there is excess pressure in the expansion tank 1. Fresh air 2a from the environment enters the expansion tank 1 via a second valve 10 when there is a vacuum in the expansion tank 1.

In the first shell 5 and/or the second shell 6, a second receptacle 11 is also formed, in which an activated carbon cartridge 12 is positively received. The expansion tank 1 shown thus has the tank housing 4 with the two receptacles 7, 11 arranged therein, in which the dryer cartridge 8 and the activated carbon cartridge 12 are arranged. If there is excess pressure in the expansion tank 1, air 2 therefore flows outwards into the environment through the first valve 9 and the activated carbon cartridge 12 arranged in the second receptacle 11, for which purpose the second valve 10 can be designed as a double valve, for example, thereby also allowing air 2 to be blown out of the expansion tank 1 into the environment. By blowing air 2 through the activated carbon cartridge 12, pollutants in particular, such as hydrocarbons, can be reliably retained. Fresh air 2a from the environment is drawn into the expansion tank 1 via the second valve 10 and the dryer cartridge 8, in which the fresh air 2a drawn in is dried.

The first valve 9 is arranged in an intermediate wall 13, which separates the second receptacle 11 from the interior 16 of the tank housing 4. The second valve 10, which can also be designed as a double valve, i.e., a valve that is permeable in both directions, is arranged in an outer wall of the tank housing 4, which separates the first receptacle 7 from the environment. Of course, the second valve 10 described above and a further pressure relief valve, via which air 2 is blown out of the expansion tank 1 into the environment, can also be arranged in the outer wall of the tank housing 4.

Looking further at FIG. 3, it can be seen that a spring 14 is provided in the first receptacle 7 and in the second receptacle 11, which pretensions the dryer cartridge 8 against the tank housing 4 and the activated carbon cartridge 12 also against the tank housing 4, in this case specifically against the intermediate wall 13. The two springs 14 allow the dryer cartridge 8 and the activated carbon cartridge 12 to be fixed in the respective receptacle 7, 11 without vibrating and therefore without rattling. In particular, this results in increased user comfort due to lower noise levels.

The first shell 5 and/or the second shell 6 can be designed as plastic injection-molded part(s), which enables not only high-quality but also cost-effective production. The two shells 5, 6 can be welded or glued together, although it is also theoretically conceivable that the two shells 5, 6 are connected to each other via clip connections or screw connections, which offers the great advantage that the tank housing 4 can be opened to replace the dryer cartridge 8 or the activated charcoal cartridge 12 and can continue to be used after the dryer cartridge 8 or the activated charcoal cartridge 12 has been replaced.

The first shell 5 and/or the second shell 6 can be made of polyoxymethylene (POM), i.e., of a plastic with high strength and low moisture absorption, which is particularly advantageous for an expansion tank 1 for air 2 of a battery cooling system 3. In order to further increase the strength and wear resistance of the tank housing 4, the plastic of the two shells 5, 6 can be reinforced with fibers, in particular glass fibers.

All in all, the expansion tank 1 and the battery cooling system 3 according to the invention can be used to create an extremely cost-effective solution compared to a dryer cartridge with a sheet metal housing.

In the following, the embodiment of an expansion tank 1′ not covered by the invention will now be briefly described in accordance with FIG. 4, whereby the same reference signs are used for the same components in FIG. 4, but with an apostrophe in each case.

According to FIG. 4, an expansion tank 1′ not covered by the invention has a tank housing 4′ made of aluminum, also with a dryer cartridge 8′ and an activated carbon cartridge 12′, wherein a first valve 9′ is arranged in the region of the activated carbon cartridge 12′, so that air 2′ can be blown out into the environment via the first valve 9′ and the activated carbon cartridge 12′ in the event of excess pressure prevailing in the tank housing 4′. Fresh air 2a′ can be drawn in from the environment via a second valve 10′ if there is a vacuum in the tank housing 4′. The fresh air 2a′ drawn in flows through the dryer cartridge 8′.

In FIG. 4, the tank housing 4′ is at least partially formed as an extruded aluminum profile, which is sealed at the longitudinal end by two end caps 15′, also made of aluminum. The end caps 15′ are, for example, detachably attached to the tank housing 4′, which means that the dryer cartridge 8′ and/or the activated carbon cartridge 12′ can be replaced without replacing the tank housing 4′ simply by removing the end caps 15′ and subsequently reattaching the end caps 15′. The dryer cartridge 8′ or the activated carbon cartridge 12′ can be pretensioned against the tank housing 4′ via corresponding springs 14′ and thus kept rattle-free.

1. An expansion tank for a battery cooling system, comprising:
a tank housing composed of a plastic, the tank housing including a first shell and a second shell connected to the first shell;
a first receptacle disposed in at least one of the first shell or the second shell;
a dryer cartridge positively received in the first receptacle;
a first valve via which air is released from the expansion tank into an environment when there is excess pressure in the expansion tank; and
a second valve via which fresh air from the environment enters the expansion tank when there is a vacuum in the expansion tank.

2. The expansion tank according to claim 1, further comprising:
a second receptacle disposed in at least one of the first shell or the second shell; and
an activated carbon cartridge positively received in the second receptacle.

3. The expansion tank according to claim 2, wherein the first valve is arranged in an intermediate wall separating the second receptacle from an interior of the tank housing.

4. The expansion tank according to claim 3, further comprising a spring pretensioning the activated carbon cartridge against the tank housing.

5. The expansion tank according to claim 1, wherein at least one of the first shell or the second shell is a plastic injection-molded part.

6. The expansion tank according to claim 1, wherein the first shell and the second shell are at least one of welded, clipped, screwed, or glued together.

7. The expansion tank according to claim 1, wherein at least one of the first shell or the second shell is composed of polyoxymethylene (POM).

8. The expansion tank according to claim 1, wherein at least one of the first shell or the second shell includes a plurality of glass fibers.

9. The expansion tank according to claim 1, wherein the second valve is arranged in an outer wall of the tank housing separating the first receptacle from the environment.

10. A battery cooling system, comprising an expansion tank according to claim 1.

11. The expansion tank according to claim 1, further comprising a spring pretensioning the dryer cartridge against the tank housing.

12. The expansion tank according to claim 11, wherein:
the second valve is disposed in an outer wall of the tank housing; and
the spring engages around the second valve and is fixed to the tank housing via the second valve.

13. The expansion tank according to claim 1, wherein at least one of the first shell or the second shell is composed of polyketone.

14. The expansion tank according to claim 8, wherein the plastic of the at least one of the first shell or the second shell has a 25% glass fiber content.

15. An expansion tank for a battery cooling system, comprising:
a first shell and a second shell connected to one another to define a tank housing, the tank housing including a first receptacle and a second receptacle each disposed between and defined by the first shell and the second shell;
a dryer cartridge positively received in the first receptacle;
an activated carbon cartridge positively received in the second receptacle;
a first valve connected to the tank housing via which air is released from the expansion tank into an environment when there is excess pressure in the expansion tank; and
a second valve connected to the tank housing via which fresh air from the environment enters the expansion tank when there is a vacuum in the expansion tank.

16. The expansion tank according to claim 15, wherein:
the tank housing further includes:
a first outer wall, a second outer wall, a third outer wall, and a fourth outer wall, the third outer wall and the fourth outer wall extending between and connecting the first outer wall and the second outer wall;
a first separating wall extending between and connecting the third outer wall and the fourth outer wall;
a second separating wall extending between and connecting the first outer wall and the first separating wall;
a third separating wall extending between and connecting the second outer wall and the first separating wall; and
an interior space including i) a first region defined by the first outer wall, the fourth outer wall, the first separating wall, and the second separating wall and ii) a second region defined by the second outer wall, the fourth outer wall, the first separating wall, and the third separating wall;
the first receptacle is defined by the first outer wall, the third outer wall, the first separating wall, and the second separating wall; and
the second receptacle is defined by the second outer wall, the third outer wall, the first separating wall, and the third separating wall.

17. The expansion tank according to claim 16, wherein:
the first valve is removably arranged in the third separating wall such that the second region of the interior space is in fluid communication with at least one of the second receptacle or the activated carbon cartridge via the first valve; and
the second valve is removably arranged in the third outer wall such that the environment is in fluid communication with at least one of the first receptacle or the dryer cartridge via the second valve.

18. The expansion tank according to claim 16, wherein at least one wall of the tank housing includes an opening disposed downstream of the second receptacle via which the environment is in fluid communication with at least one of the second receptacle or the activated carbon cartridge.

19. The expansion tank according to claim 16, further comprising:
a first spring arranged in the first receptacle between the dryer cartridge and the third outer wall, the first spring pretensioning the dryer cartridge against the second separating wall; and
a second spring arranged in the second receptacle between the activated carbon cartridge and the third outer wall, the second spring pretensioning the activated carbon cartridge against the third separating wall.

20. The expansion tank according to claim 19, wherein:
the first spring compresses a dryer granulate of the dryer cartridge such that the dryer granulate has no room to move; and
the second spring compresses an activated carbon of the activated carbon cartridge such that the activated carbon has no room to move.
